(19) United States
(12) Patent Application Publication
(10) Pub. No.: US 2015/0214861 A1
(43) Pub. Date: Jul. 30, 2015

(54) ASSEMBLY HAVING A MULTILAYER ACTUATOR

(71) Applicant: ROBERT BOSCH GmbH, Stuttgart (DE)

(72) Inventor: Istvan Denes, Waiblinge/Hohenacker (DE)

(21) Appl. No.: 14/428,571

(22) PCT Filed: Aug. 28, 2013
(86) PCT No.: PCT/EP2013/067808

§ 371 Date: Mar. 16, 2015

(30) Foreign Application Priority Data
Sep. 17, 2012 (DE) 10 2012 216 564.9

(51) Int. Cl. H02N 1/00; F04B 43/04; F04B 43/02

(52) U.S. Cl. CPC H02N 1/006; F04B 43/025; F04B 43/04

(57) ABSTRACT

An assembly is described having at least one multilayer actuator having at least two electrode layers, between which an elastic dielectric layer made of an electrically non-conducting material, is situated, and the multilayer actuator is in mechanical connection, especially in direct contact with, a pressurized medium and displaces it from a working chamber when the multilayer actuator is actuated.

### FIELD OF THE INVENTION

The present invention relates to an assembly and to a multilayer actuator, especially for use in an assembly according to the present invention.

### BACKGROUND INFORMATION

A multilayer actuator which is made up of a multitude of electrode layers stacked on top of each other and has flexible dielectric layers made of a dielectric material that are situated between the electrode layers is discussed in the publication DE 10 2008 002 489 A1 of the applicant. In order to achieve higher mechanical loading of the multilayer actuator in the direction of tensile forces, the deformable layers in the known multilayer actuator are linked to each other and/or the electrode layers are linked to at least one of the deformable layers. Such multilayer actuators are used especially for the adjustment or movement of elements. In this case, the multilayer actuators are connected to an element to be adjusted, such as a rod or the like, for example. By applying an electrical voltage to the electrode layers, the element is moved by the mutual attraction of the electrode layers, accompanied by a simultaneous expansion of the deformable layers situated between the electrode layers. In addition, application cases are known in which an element is connected to a multilayer actuator and the element is moved by an external force and in this way deforms, especially compresses, the multilayer actuator. A multilayer actuator can therefore be used for the generation of currents.

### SUMMARY OF THE INVENTION

Proceeding from the described discussed references, the present invention is based on the objective of creating an assembly using at least one multilayer actuator, which can be utilized in a multitude of ways. According to the present invention, in an assembly having the features described herein, this is achieved in that the at least one multilayer actuator is in mechanical connection, especially in direct contact, with a pressurized medium and displaces it from a working chamber when the multilayer actuator is actuated. Such a configuration of the assembly makes it possible to realize the most varied advantageous application cases that result from the displacement of the pressurized medium by the multilayer actuator. Application cases of this kind may consist of, but are not limited to, the use of the assembly to adjust an element with the aid of an actuating element connected to the assembly, or else, for example, of the conveyance of pressurized media, for which purpose the assembly may be configured in the form of a pump.

Advantageous refinements of the assembly according to the present invention are described in the further description herein. The scope of the present invention encompasses all combinations of at least two of the features described in the claims, the description and/or the figures.

In a first structural configuration of the assembly, the working chamber is delimited or formed by what may be a rigid housing in which the multilayer actuator is situated. In other words, this means that the pressurized medium is likewise located within the (rigid) housing. For one, this makes it possible to realize an especially robust configuration of the assembly since the pressurized medium in the housing is accommodated in a relatively protected manner. For another, a fairly uncomplicated configuration of the multilayer actuator is realizable in this way since the actuator is situated inside the housing in a protected manner, as well.

In one alternative or additional configuration, it may be provided to create the working chamber in the multilayer actuator. Such a configuration, for example, makes it possible that a housing surrounding the multilayer actuator provides merely the mechanical protection of the actuator but need not be hydraulically tight with regard to the pressurized medium.

In a further embodiment of the present invention, the working chamber is connected to a reservoir for the pressure media, and the connection between the working chamber and the reservoir is controllable with the aid of a valve device. This means, in particular, that the valve device may be used to open or close the connection between the working chamber and the reservoir. This configuration mechanically reinforces the multilayer actuator, so that, for example, it is able to absorb very high tensile or pressure forces, without the actuator being damaged or destroyed. In one specific embodiment the multilayer actuator cooperates with an actuating element, especially an actuating rod, toward this end.

Another specific embodiment of the present invention, in which an actuating rod or an actuating element is used, provides for the use of two multilayer actuators, whose working chambers are coupled to each other by a connection that includes a blocking element, and both multilayer actuators are connected to the actuating element. Such a configuration makes it possible to actively move the actuating element in different directions in each case, and adjustment forces in both directions are able to be generated.

Another use of an assembly according to the present invention consists of the embodiment of a pump. Here, the working chamber is connected to a line in which a branch-off is situated, which is connected to a reservoir for pressurized media on one side and to a pressure line on the other, and a valve device, especially a non-return valve, is situated in the connection between the branch-off and the pressure line and between the branch-off and the reservoir. Such a configuration makes it possible to aspirate the pressurized medium from the reservoir in a first phase, and to pump the pressurized medium into a pressure line under increased pressure in a second phase.

The present invention also includes a multilayer actuator, especially for use in an assembly according to the present invention. In the present invention it is provided that the multilayer actuator forms at least one longitudinal channel, which is part of the working chamber for a pressurized medium, across at least a partial length in the longitudinal direction of the multilayer actuator. This configuration of the multilayer actuator enables a displacement of the pressure medium from the longitudinal channel into the multilayer actuator when an electrical voltage is applied at the electrode layers.

In one constructive configuration of the multilayer actuator, the electrode layer is made up of a rigid outer ring and a central region which, at least in the currentless state, is disposed in the outer ring with a radial gap, and the at least one longitudinal channel is configured in the central region. This allows the central region to radially expand toward the outside when an electrical voltage is applied at the electrode layer, without the overall diameter of the multilayer actuator growing larger.

To prevent electrical short circuits between the electrode layers in the production of the multilayer actuator or the longitudinal channels, it furthermore may be provided that the electrode layer does not extend up to the longitudinal channel in the central region.

Additional advantages, features and details of the present invention derive from the following description of exemplary embodiments as well as from the figures.

### BRIEF DESCRIPTION OF THE DRAWINGS

FIG. 1 and FIG. 2 show a first assembly according to the present invention, in different operating positions, in a longitudinal section in each case.

FIG. 3 shows a second assembly according to the present invention, in a first operating position, in a longitudinal section.

FIG. 4 shows a detail of the assembly according to FIG. 3, in a longitudinal section.

FIG. 5 shows the second assembly of the present invention according to FIG. 3, in a second operating position and likewise in a longitudinal section;

FIG. 6 shows a detail from FIG. 5, in an enlarged view in a longitudinal section.

FIG. 7 and FIG. 8 show a third assembly according to the present invention, in different operating positions, in a longitudinal section in each case;

FIG. 9 and FIG. 10 show a cross section through an electrode layer in an assembly of the present invention, according to FIGS. 3 and 5.

FIG. 11 and FIG. 12 show a detail from FIG. 9 in a plan view.

FIGS. 13 and 14 show a fourth and a fifth assembly according to the present invention configured as a pump, in a simplified longitudinal section.

### DETAILED DESCRIPTION

The same elements and elements having the same function are provided with the same reference numerals in the figures.

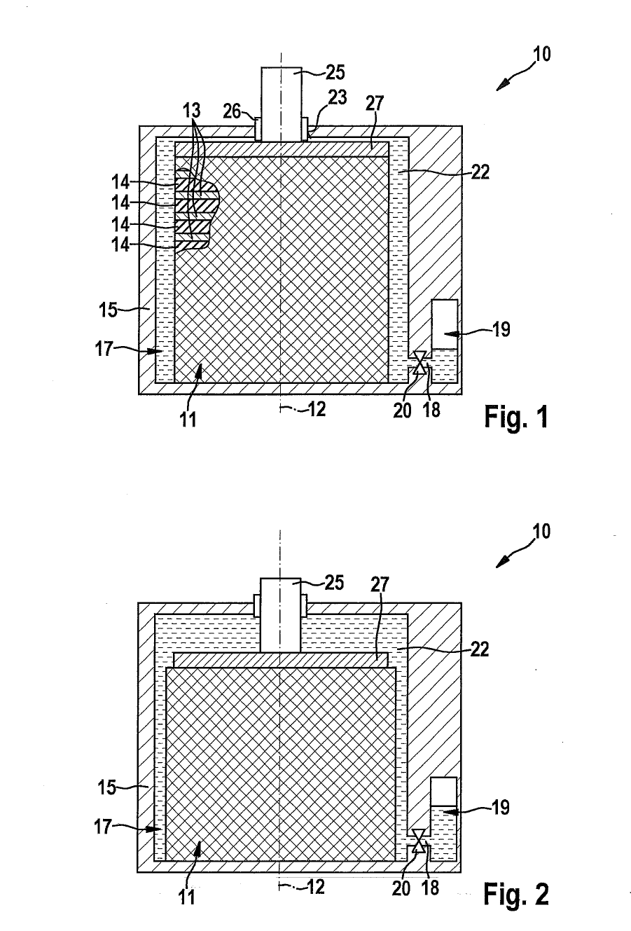

A first assembly 10 according to the present invention is represented in FIGS. 1 and 2. Assembly 10 includes a multilayer actuator 11, which is made up of a multitude of electrode layers 13 stacked on top of one another in relation to a longitudinal axis 12 of multilayer actuator 11; situated between two electrode layers 13 in each case is an elastic dielectric layer 14 made of an electrically non-conducting or dielectric material. As a rule, electrode layers 13 are configured as foil layers or as coating, which means that the thickness of electrode layers 13 is much lower than the thickness of dielectric layer 14. Electrode layers 13 are connected to a voltage supply (not shown).

Corresponding to DE 10 2008 002 489 A1 of the applicant, multilayer actuator 11 may be characterized in that dielectric layers 14 are linked to one another and/or electrode layers 13 are linked to at least one of dielectric layers 14. Such an already known multilayer actuator 11 is characterized by the fact that when a voltage is applied to electrode layers 13, their mutual clearance becomes smaller as a result of the forces of attraction, and dielectric layers 14 disposed between electrode layers 13 are deformed in the transverse direction, i.e., perpendicularly to longitudinal axis 12, the volume of multilayer actuator 11 remaining constant overall. Multilayer actuator 11 is disposed inside what may be a rigid housing 15, with radial clearance from the wall of housing 15. In its interior, housing 15 has a working chamber 17 for the accommodation of multilayer actuator 11, and a reservoir 19 which is separated from working chamber 17 by a connection channel 18. Furthermore, a valve device 20 in the form of a shutoff valve is situated in connection channel 18. It is of course within the scope of the present invention to place reservoir 19 outside housing 15 in a separate housing or a similar setup, and to connect reservoir 19 to working chamber 17 with the aid of a corresponding connection line.

A pressurized medium 22 is situated inside housing 15, especially inside the region in working chamber 17 that surrounds multilayer actuator 11, as well as in reservoir 19. Pressurized medium 22 may be an (incompressible) fluid such as an hydraulic oil, for example. On the upper side of housing 15, the housing is provided with an opening 23, which is penetrated by an actuating element such as a piston rod 25, for example. A sealing element 26 hydraulically seals opening 23 in the direction of piston rod 25. Piston rod 25 is coupled to multilayer actuator 11 via a connection board 27, which is fixedly connected to the one end face of multilayer actuator 11.

FIG. 1 shows the state of multilayer actuator 11 in which no voltage is applied at electrode layers 13. Pressurized medium 22 surrounds multilayer actuator 11 and completely fills working chamber 17, while reservoir 19 is partially filled with pressurized medium 22. FIG. 2 shows the state of multilayer actuator 11 in which a voltage is applied at electrode layers 13. As a result, electrode layers 13 are mutually attracted to one another in the known manner, so that dielectric layers 14 situated between electrode layers 13 are deformed in a direction transversely to longitudinal axis 12. A shortening of multilayer actuator 11 in the direction of longitudinal axis 12 therefore takes place, which has the result that piston rod 25 is pulled into the interior of housing 13 via connection board 27. Because of the additional volume of piston rod 25 projecting into working chamber 17, pressurized media 22 is displaced from working chamber 17 into reservoir 19 when valve device 20 is open. This makes it possible, for example, to move or adjust an element via piston rod 25, using multilayer actuator 11. If valve device 20 is then closed in the particular setting of multilayer actuator 11 shown in FIG. 2, so that no pressurized medium 22 from reservoir 19 is able to flow back into working chamber 17, then a relatively high pressure force is able to be exerted on multilayer actuator 11 via piston rod 25, on account of incompressible pressurized medium 22 in working chamber 17, without deforming or damaging multilayer actuator 11.

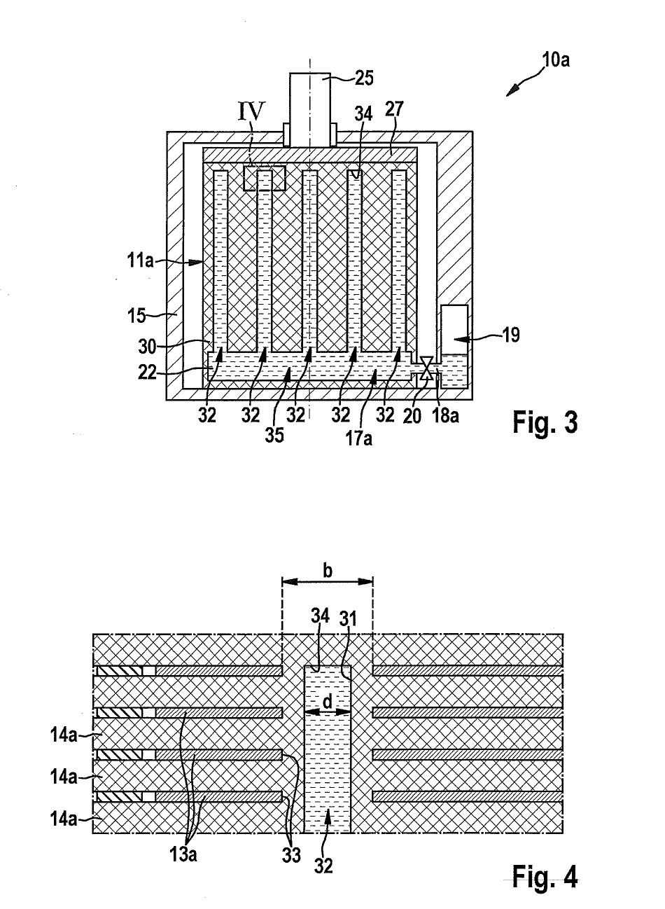

FIG. 3 through 6 show a modified assembly 10a, which differs from assembly 10 in that working chamber 17a is configured to accommodate pressurized medium 22 within multilayer actuator 11a. Multilayer actuator 11a disposed inside housing 15 continues to cooperate with a piston rod 25, but in contrast to assembly 10, it is not necessary to hydraulically seal housing 15 in the region of the throughfeed of piston rod 25. For the hydraulically tight accommodation of pressurized medium 22, multilayer actuator 11a includes a sealed outer sheath 30, whose one end face is connected to piston rod 25 via connection board 27, analogous to assembly 10. As can be gathered from FIGS. 4 and 6, in particular, dielectric layers 14a are provided with openings 31 that are mutually aligned and which form longitudinal channels 32 that extend in the longitudinal direction of multilayer actuator 11a.

Longitudinal channels 32 form a portion of working chamber 17a. Electrode layers 13a have openings 33, as well, diameter D of openings 33 being greater than diameter d of openings 31. In the manufacturing process of multilayer actuator 11a, a linking process of the material of two dielectric layers 14a disposed one above the other then takes place, so that because of different diameters d, D of openings 31 and 33, electrode layers 13a do not extend up to longitudinal channels 32 but instead are surrounded by the (linked) material of dielectric layers 14a in their radially inner region.

Longitudinal channels 32 may be evenly distributed across the in particular round cross section of multilayer actuator 11a, e.g., on one or more hole circle(s). Longitudinal channels 32 are configured on the side facing connection board 27, in the manner of a blind hole having a bottom 34. On the side facing away from connection board 27, longitudinal channels 32 terminate in a collection space 35, serving as working chamber, within outer sheath 30 of multilayer actuator 11a. Connection channel 18a in turn branches off from collection space 35 in the direction of reservoir 19.

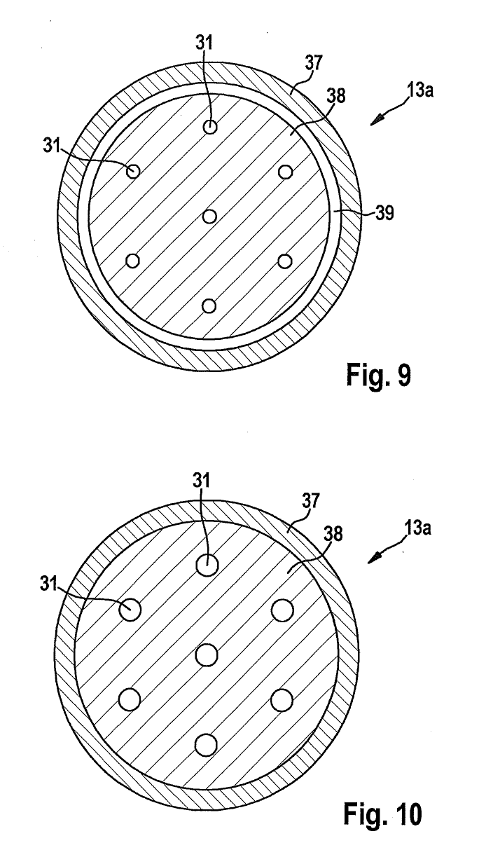

As can be gathered from an overall view of FIGS. 9 and 10, in particular, electrode layers 13a of multilayer actuator 11a are made up of a rigid outer ring 37 and a central region 38 of deformable material, which is situated radially within outer ring 37. FIG. 9 shows the state of multilayer actuator 11a in which no voltage is applied at electrode layers 13a. An annular gap 39 is formed between central region 38 and outer ring 37 in that state. In contrast, FIG. 10 shows the state in which a voltage is applied at electrode layers 13a. In this state, central region 38, together with dielectric layers 14a connected to central regions 38, deforms in such a way that the diameter of central region 38 becomes larger and possibly reaches up to outer ring 37. A further deformation of electrode layers 13a is prevented by the rigid configuration of outer ring 37, so that electrode layers 13a always have the same outer diameter overall, regardless of whether or not a voltage is applied.

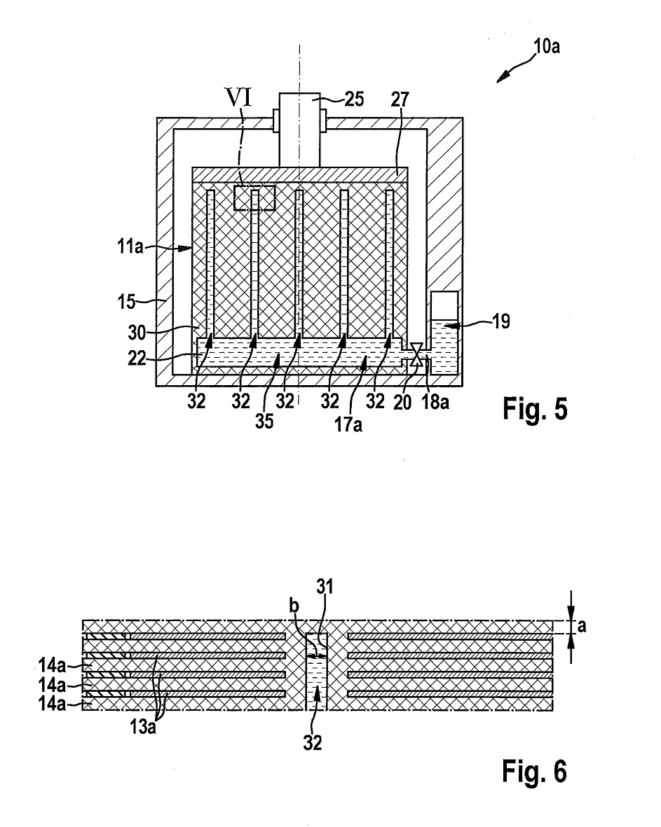

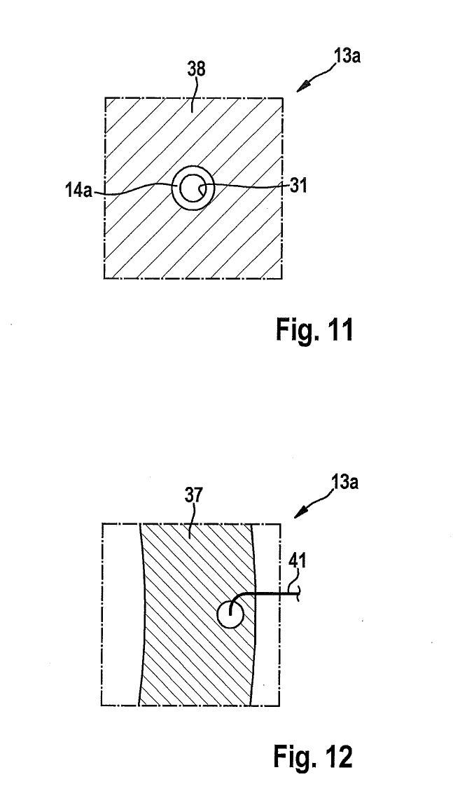

It can furthermore be gathered from FIG. 11 that electrode layer 13a of central region 38 does not extend up to the edge of opening 31 of dielectric layer 14a situated underneath, but is set apart therefrom. When multilayer actuator 11a is manufactured, a dielectric layer 14a in liquid form is applied on dielectric layer 14a lying underneath, and is linked in a subsequent step, possibly with the aid of UV or IR radiation. In the cross-linking phase, an adhesive action between dielectric layers 14a takes place in locations where no electrode layers 13a are present. This ensures that openings 31 are invariably situated on top of each other according to the illustration of FIGS. 3 and 5, regardless of whether a voltage is applied at electrode layers 13a and, in particular, that no contact takes place between pressurized medium 22 and electrode layers 13a.

FIG. 12 shows a portion of outer ring 37. It is created by metallization, in particular. Because outer ring 37 does not take part in a radial expansion when a voltage is applied, outer ring 37 is particularly suitable for undertaking the current supply via a line 41 to electrode layer 13a. In addition, an electrical connection (not shown) between outer ring 37 and inner ring 38 is provided.

The fact that pressurized medium 22 is not in contact with electrode layers 13a makes it unnecessary for pressurized medium 22 to be electrically non-conductive. It is furthermore mentioned that a high dielectric constant of pressurized medium 22 enhances the function of multilayer actuator 11a.

FIG. 3 shows the state in which no voltage is applied at electrode layers 13a or multilayer actuator 11a. Longitudinal channels 32 have diameter d analogous to FIG. 4. When a voltage is applied at electrode layers 13a, the diameter of longitudinal channels 32 decreases to diameter b according to the illustration of FIGS. 5 and 6, pressurized medium 22 being displaced from longitudinal channels 32 into collection space 35 and from there, via connection channel 18a, into reservoir 19.

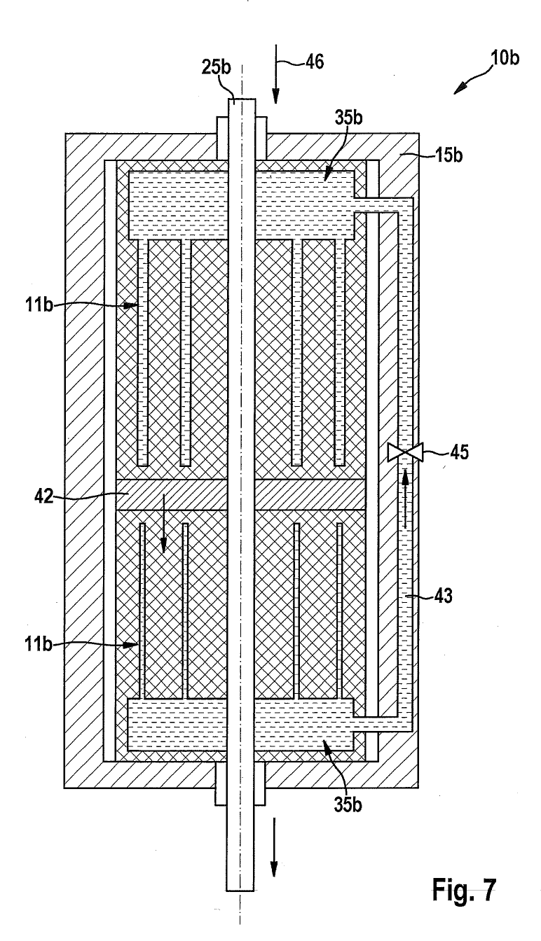

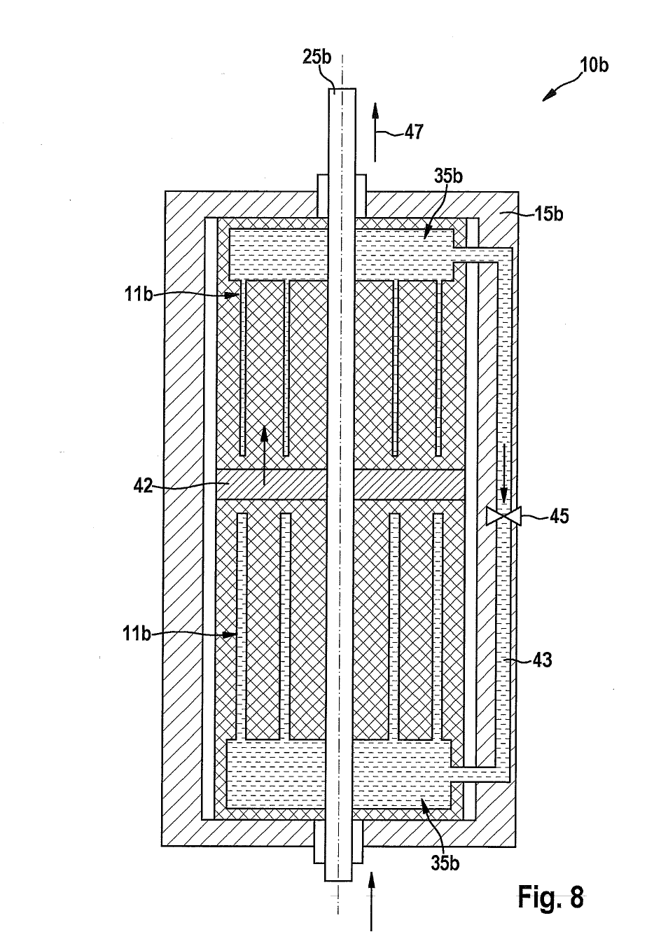

A further, modified assembly 10b is shown in FIGS. 7 and 8. Assembly 10b differs from assemblies 10 and 10a in that assembly 10b has two multilayer actuators 11b, which follow each other in the longitudinal direction and may have the same configuration. The two multilayer actuators 11b are once again accommodated in a shared housing 15b, which is penetrated by an actuating element in the form of a piston rod 25b, just like multilayer actuators 11b. Multilayer actuators 11b are configured in a manner analogous to multilayer actuator 11a, but they are mirror-inverted with respect to each other in relation to a coupling plate 42. Collection spaces 35b, acting as working chambers, of multilayer actuators 11b are interconnected via a connection channel 43 situated inside housing 15b, for instance, and a valve device 45 in the form of a shutoff valve is disposed in connection channel 43.

FIG. 7 shows the switching state of assembly 10b, in which a voltage is applied in lower multilayer actuator 11b in the drawing plane, while no voltage is applied in upper multilayer actuator 11b in the drawing plane. This displaces pressurized medium 22 from collection space 35b of lower multilayer actuator 11b into collection space 35b of upper multilayer actuator 11b when valve device 45 is open, and piston rod 25b is moved in the downward direction, as represented by arrow 46. If valve device 45 is closed in the position shown in FIG. 7, then a tensile force acting counter to the direction of arrow 46 is able to be absorbed via piston rod 25b, without deformation of or damage to multilayer actuator 11b.

To move piston rod 25b in the opposite direction according to arrow 47 of FIG. 8, upper multilayer actuator lib in the drawing plane has a voltage applied, whereas the lower multilayer actuator 11b in the drawing plane is switched to the currentless state.

This displaces pressurized medium from collection space 35b of upper multilayer actuator 11b into collection space 35b of lower multilayer actuator 11b.

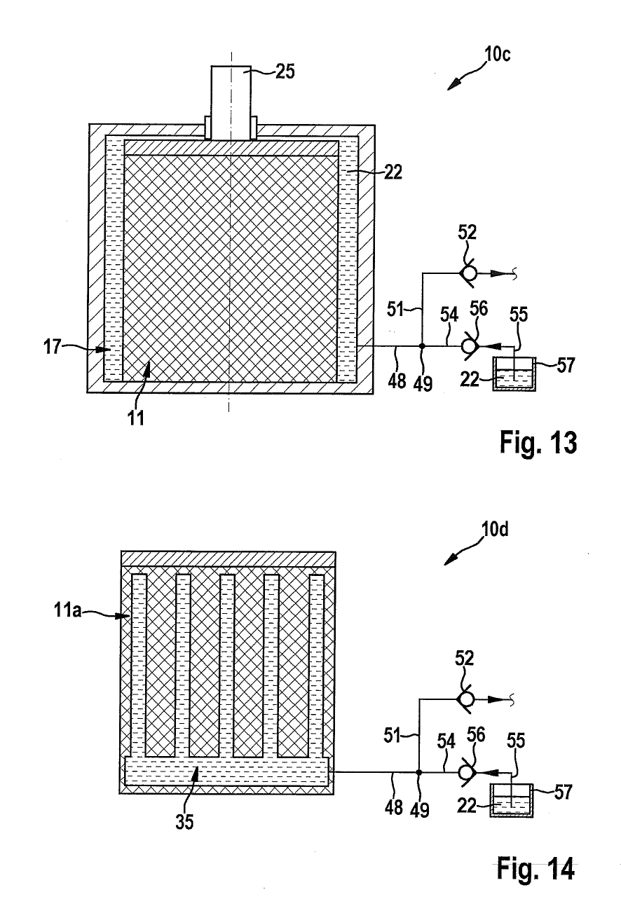

A further assembly 10c according to the present invention is shown in FIG. 13. Assembly 10c has a pump function or is configured in the form of a pump. Assembly 10c differs from assembly 10 according to FIGS. 1 and 2 in that working chamber 17 is connected via a line 48 to a branch-off 49 that leads into two directions. One branch 51 is connected to a pressure line 53 by way of a non-return valve 52. In contrast, other branch 54 is connected to a reservoir 57 for pressurized medium 22 via a suction line 55 and a non-return valve 56 connected in-between. In the setting of assembly 10c shown in FIG. 13, no voltage is applied at its multilayer actuator 11. Working chamber 17 is completely filled with pressurized medium 22. Non-return valve 56 blocks, while non-return valve 52, which is connected to pressure line 53, is open. If a voltage is then applied at multilayer actuator 11, pressurized medium 22 is conveyed from working chamber 17 and via line 48 into pressure line 53. Once the supply has ended or once the voltage supply of multilayer actuator 11 is interrupted, non-return valve 52 blocks, while pressurized medium 22 is conveyed from reservoir 57 into working chamber 17 via non-return valve 56 and suction line 55. In the subsequent reapplication of the voltage to multilayer actuator 11, the pressurized medium 22 most recently supplied from reservoir 57 is conveyed into pressure line 53 again.

Finally, an assembly 10d that has been modified even further in comparison with FIG. 13 is shown, which differs from assembly 10c of FIG. 13 by the use of a multilayer actuator 11a according to FIG. 3 through 6. In contrast to assembly 10c, no separate housing 15 is therefore required in assembly 10d.

Assemblies 10, 10a through 10d described up to this point may be adapted or modified in various ways, without deviating from the inventive idea. According to this idea, the respective multilayer actuator 11, 11a and 11b used in the individual case is to be placed in at least indirect contact with a pressurized medium 22, in such a way that when a voltage is applied at multilayer actuator 11, 11a, 11b, pressurized media 22 is displaced from working chamber 17, 17a or collection space 35, 35b. For example, through the capacitance change of multilayer actuators 11, 11a, 11b, it is possible to obtain information about their deformation and consequently about the position of piston rod 25, 25b. Such a configuration, for instance, may be used to realize a closed-loop control for a servo-actuator or for an actively controlling shock-absorber application.

1-10. (canceled)

11. An assembly, comprising:
at least one multilayer actuator having at least two electrode layers, between which an elastic dielectric layer made of electrically non-conducting material is situated;
wherein the multilayer actuator is in at least one of mechanical connection and direct contact with a pressurized medium and displaces it from a working chamber when the multilayer actuator is actuated.

12. The assembly of claim 11, wherein the working chamber is delimited or formed by a housing, in which the multilayer actuator is situated.

13. The assembly of claim 11, wherein the working chamber is formed in the multilayer actuator.

14. The assembly of claim 11, wherein the working chamber is connected to a reservoir for the pressurized medium, and wherein the connection between the working chamber and the reservoir is controllable with a valve device.

15. The assembly of claim 11, wherein the multilayer actuator cooperates with an actuating element.

16. The assembly of claim 15, further comprising:
two multilayer actuators having working chambers which are coupled to each other by a connection having a blocking element, wherein both of the multilayer actuators are connected to the actuating element.

17. The assembly of claim 11, wherein the working chamber is connected to a line in which a branch-off is situated, which is connected to a reservoir for pressurized medium on one side and to a pressure line on the other side, and wherein a separate valve device is situated in the connection between the branch-off and the pressure line and between the branch-off and the reservoir.

18. A multilayer actuator for an assembly, comprising:
a multilayer actuator arrangement, wherein at least one longitudinal channel is formed over at least a partial length in the longitudinal direction of the multilayer actuator arrangement, which forms a portion of a working chamber for a pressurized medium;
wherein the assembly includes at least one of the multilayer actuator arrangement, which has at least two electrode layers, between which an elastic dielectric layer made of electrically non-conducting material is situated, and wherein the multilayer actuator arrangement is in at least one of mechanical connection and direct contact with the pressurized medium and displaces it from the working chamber when the multilayer actuator arrangement is actuated.

19. The multilayer actuator of claim 18, wherein the electrode layer includes a rigid outer ring and a central region situated in the outer ring with a radial gap, at least in the currentless state, and the at least one longitudinal channel is configured in the central region.

20. The multilayer actuator of claim 19, wherein the central region of the electrode layer does not reach up to the longitudinal channel.

21. The multilayer actuator of claim 18, wherein the central region of the electrode layer does not reach up to the longitudinal channel.

22. The assembly of claim 11, wherein the working chamber is delimited or formed by a rigid housing, in which the multilayer actuator is situated.

23. The assembly of claim 11, wherein the working chamber is connected to a reservoir for the pressurized medium, and wherein the connection between the working chamber and the reservoir is controllable with a valve device, which is a shutoff valve.

24. The assembly of claim 11, wherein the multilayer actuator cooperates with an actuating element, which is an actuation rod.

25. The assembly of claim 11, wherein the working chamber is connected to a line in which a branch-off is situated, which is connected to a reservoir for pressurized medium on one side and to a pressure line on the other side, and wherein a separate valve device, which is a non-return valve, is situated in the connection between the branch-off and the pressure line and between the branch-off and the reservoir.
